(19) United States
(12) Patent Application Publication
(10) Pub. No.: US 2024/0421671 A1
(43) Pub. Date: Dec. 19, 2024

(54) DEVICE FOR THE ALIGNMENT OF CONDUCTIVE ELEMENTS

(71) Applicant: ATOP S.P.A., Barberino (IT)

(72) Inventor: Rubino CORBINELLI, Poggibonsi, Frazione Staggia Senese (IT)

(21) Appl. No.: 18/706,990

(22) PCT Filed: Nov. 4, 2022
(86) PCT No.: PCT/EP2022/080828

§ 371 Date: May 2, 2024

(30) Foreign Application Priority Data
Nov. 10, 2021 (IT) 102021000028556

(51) Int. Cl. H02K 15/00; H02K 15/085

(52) U.S. Cl. CPC H02K 15/0087; H02K 15/085

(57) ABSTRACT

An alignment device of conductive elements which comprises a frame temporarily supporting a ferromagnetic core comprising slots on the inner circumference and able to accommodate a plurality of conductive elements. Each conductive element has hairpin shape or two straight portions and a bridge portion, whereby each straight portion comprises a terminal with an free end front; the device comprises a pusher attached to movement elements, providing a programmable and predefined stroke, movable between a first position of maximum distance from the ferromagnetic core and a second position of minimum distance; a flat surface of the pusher is facing the terminal fronts, if core and pusher are in first position; the flat surface abuts and bends the fronts if core and pusher are in second position.

The present invention relates to a device for the alignment of conductive elements: in particular the device is adapted to execute alignment operations on conductive elements (conductors of electricity, i.e. that are electrically conductive) that constitute the inductive windings (or spools) of electric machines, such as motors, generators and, in general, any other type of electric machine.

The device according to the invention is adapted to be used in a system that carries out processes of stable coupling (for example through mutual welding) of the ends of pairs of conductive elements, in which each conductive element will form part of an inductive spool and will be shaped like a fork. Such conductive elements are inserted into the slots of a core of an electric machine, and in the jargon used in the sector they are normally called “hairpins”. The fork has two straight shanks which are mutually connected at one end by a bridge-like cross-piece. Overall the forks are shaped approximately like an upturned U with the bridge shaped like a cusp. Each shank has a free end for inserting the fork into the slots of a core, such as an inductor or an armature of an electric machine.

The insertion occurs by inserting the free ends of the conductive elements through longitudinal openings of the slots and making them slide until they come out at the other end of the ferromagnetic core, until a predefined external protrusion of the shanks is reached. So at one end of the ferromagnetic core, the bridges of the forks remain outside, while at the other end of the ferromagnetic core the free ends remain outside.

After insertion, the free ends are bent in order to be arranged in predetermined positions, at which they are connected with other free ends of other conductive elements (forks) via welding. The welding operation can occur by heating using a heating element, or with a laser beam striking the heads of two free ends arranged adjacently in order to be connected: the melting of the material of the two heads generates a connecting join that complies with the required mechanical and electrical characteristics, and therefore closes the circuit of the inductive winding according to a predefined electrical diagram. The free ends of separate conductive elements must therefore be arranged according to criteria for mutual alignment that make the welding operations simple and which ensure a high stability of the coupling. For the manufacture of electric machines of recent design (which are increasingly optimized), it has become necessary to revise the apparatuses and processes that perform the alignment of the free ends, as they require a high level of precision in the positioning of the free ends, which is necessary for their correct welding.

The required increase in precision goes hand in hand with the need to implement increasingly rapid production cycles, demands that require the alignment of the free ends of the conductive elements in a rapid and precise manner.

The aim of the present invention is to solve the above mentioned drawbacks, by providing a device for the alignment of conductive elements that is particularly precise.

Within this aim, an object of the invention is to provide a device for the alignment of conductive elements that is adapted to arrange the front of the ends of pairs of conductive elements at the same height.

Another object of the invention is to provide a device for the alignment of conductive elements of the completely automated type.

Another object of the invention is to provide a device for the alignment of conductive elements that rapidly determines the condition of desired alignment.

Another object of the invention is to provide a device for the alignment of conductive elements that can be associated with other, conventional alignment devices.

Another object of the present invention is to provide a device for the alignment of conductive elements which is of low cost and easily and practically implemented and safe in use.

This aim and these objects are achieved by a device for the alignment of conductive elements according to claim 1.

Such aim and objects are also achieved by a method for the alignment of conductive elements according to claim 6.

Further characteristics and advantages of the invention will become better apparent from the detailed description that follows of a preferred, but not exclusive, embodiment of the device for the alignment of conductive elements, which is illustrated by way of non-limiting example in the accompanying drawings wherein:

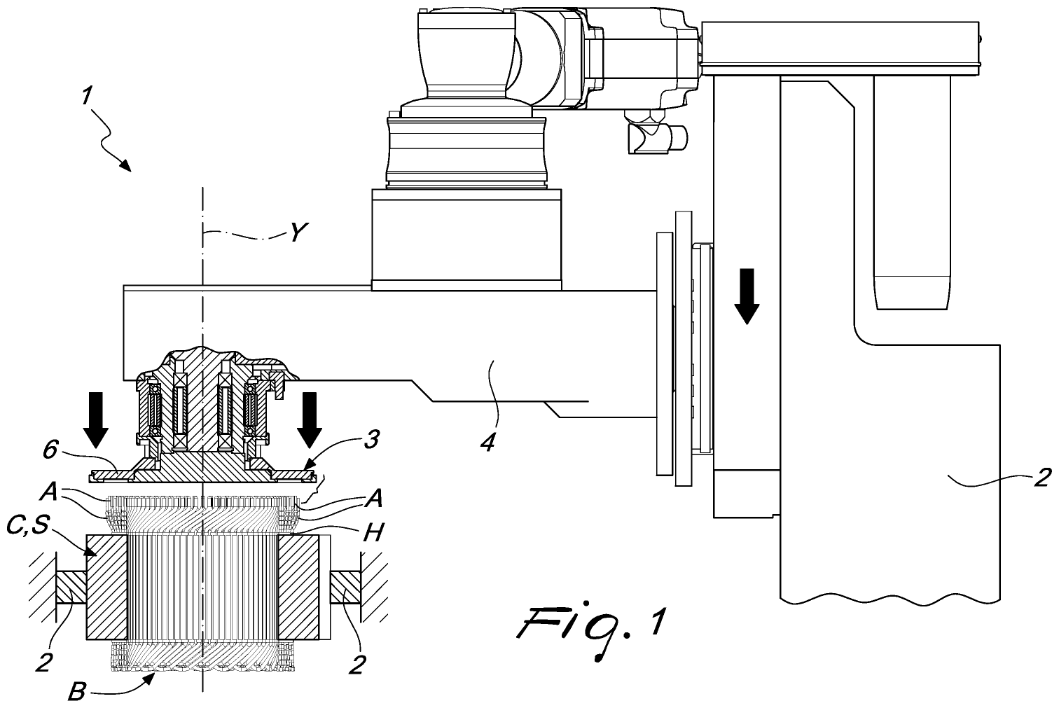

FIG. 1 is a schematic side view of a possible embodiment of a device for the alignment of conductive elements according to the invention in a first operating configuration of maximum distance from the ferromagnetic core into which the conductive elements are inserted;

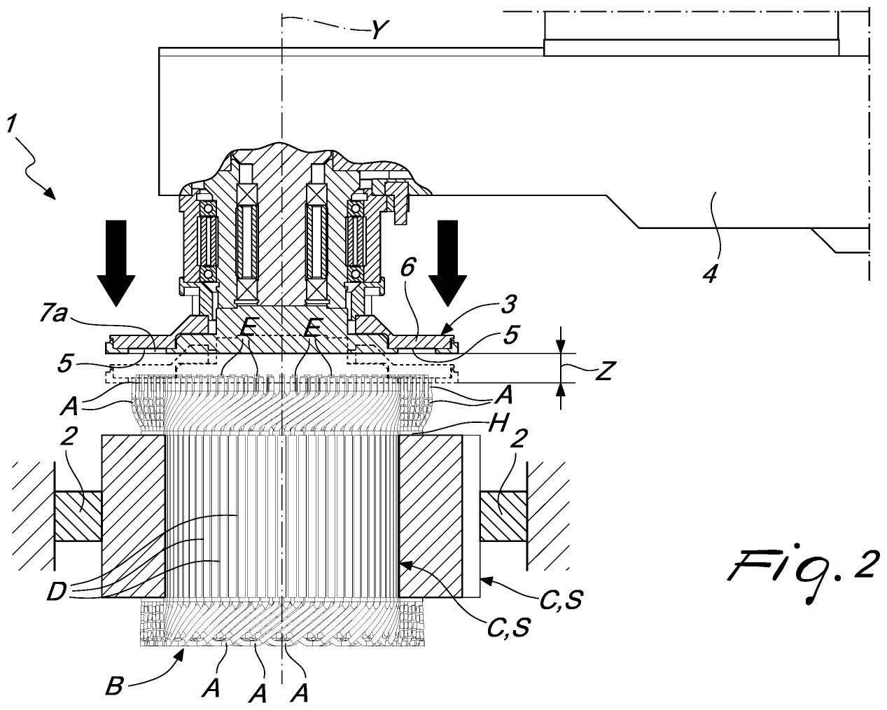

FIG. 2 is an enlarged schematic side view of a detail of FIG. 1;

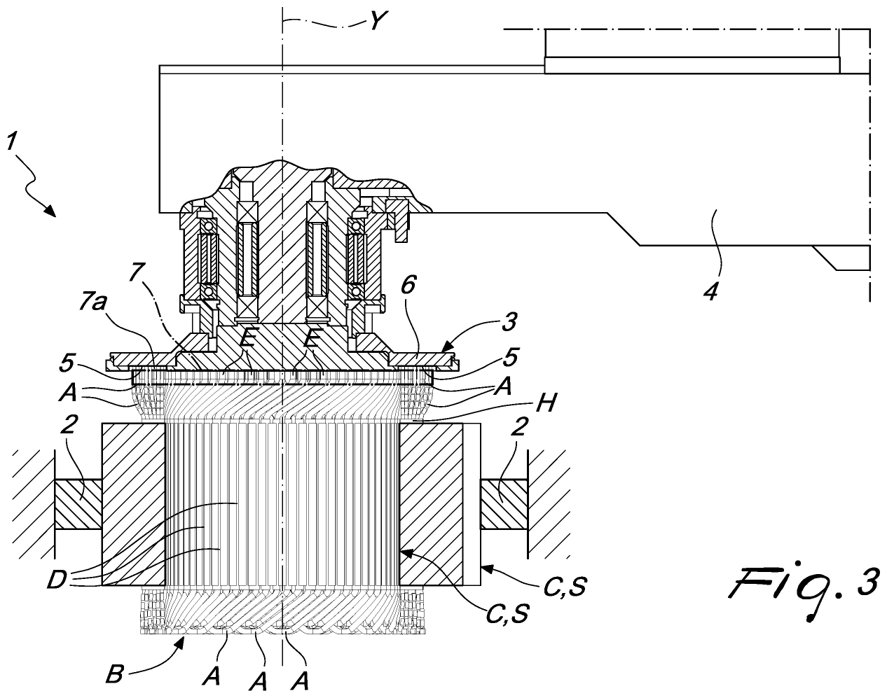

FIG. 3 is an enlarged schematic side view of an enlarged detail of the device of FIG. 1 in a second operating configuration of minimum distance from the ferromagnetic core, for the alignment of the terminal fronts of the conductive elements;

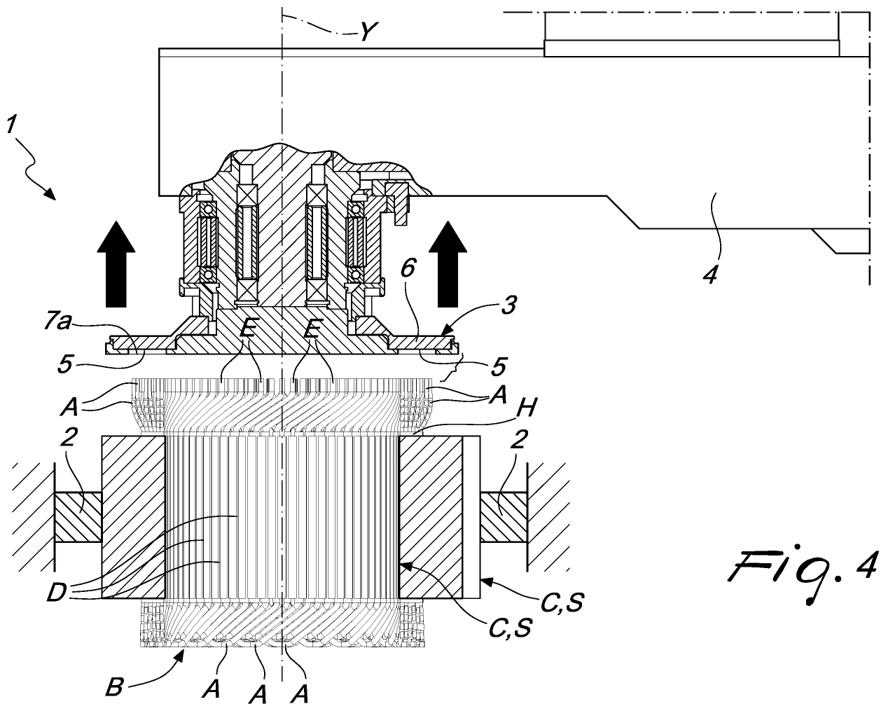

FIG. 4 is an enlarged schematic side view of an enlarged detail of the device of FIG. 1 being moved away from the ferromagnetic core after having aligned the terminal fronts of the conductive elements;

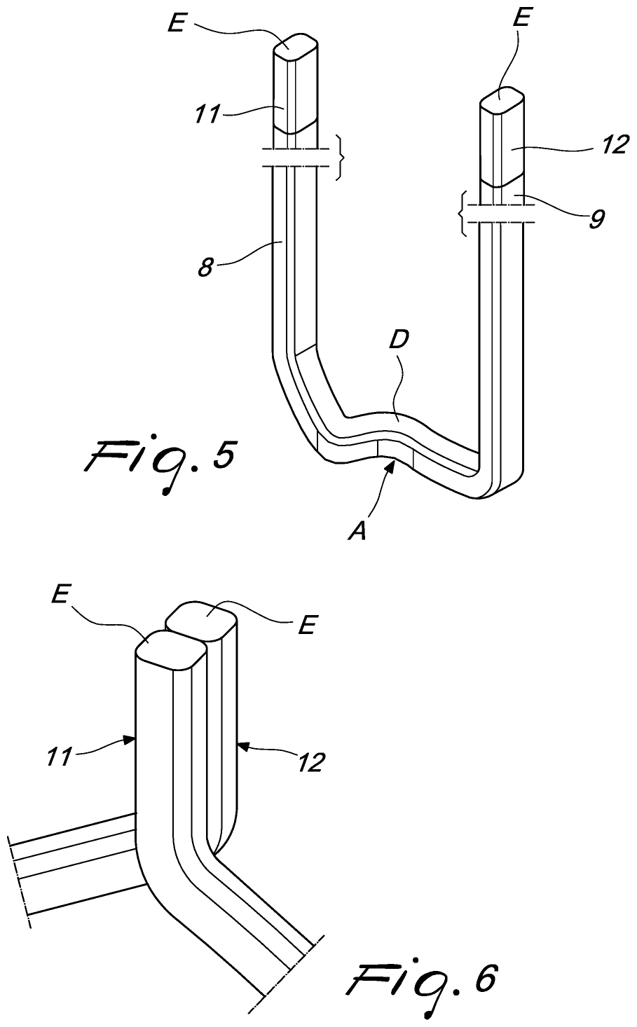

FIG. 5 is a schematic side view of a possible embodiment of a conductive element;

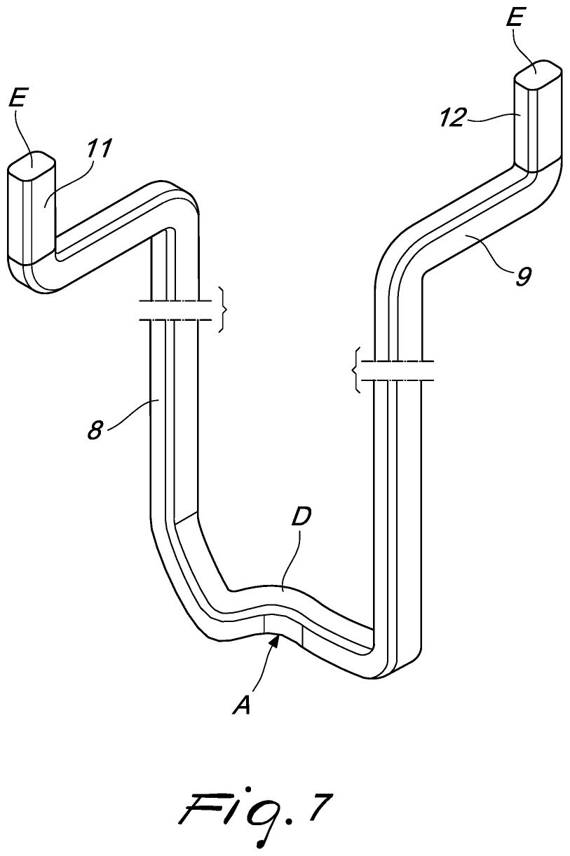

FIG. 6 is a schematic side view of a possible embodiment of a group of two terminal portions of separate conductive elements;

FIG. 7 is a schematic side view of a possible embodiment of a conductive element after the operations for alignment.

With particular reference to the figures, the reference numeral 1 generally designates a device for the alignment of conductive elements A. It should be noted that, in a possible application of certain practical interest (illustrated for the purposes of non-limiting example), such conductive elements A can be designed for the manufacture of inductive windings B. The term “conductive elements” A in the present discussion is used to encompass any component made of electrically conducting material, such as, for example, copper, aluminum and other metals and alloys thereof.

Each conductive element A will be shaped like a fork and will comprise two shanks 8, 9 which are mutually connected by a bridge-shaped cross-piece 10, known as hairpin. The shanks 8, 9 have terminal portions 11, 12 which have a respective flat front E, arranged at the free end thereof.

The device 1 comprises a frame 2 for the temporary support of a ferromagnetic core C which has respective slots D, which are configured to accommodate a plurality of shanks 8, 9 of specific conductive elements A.

The ferromagnetic core (C) comprises a central axis of symmetry (Y).

The device further comprises at least one grouping element 7 configured for grouping terminal portions 11, 12 of groups of at least two conductive elements A.

It should be noted that, optionally, it is possible that such element 7, once the grouping has been performed, can also be capable of bringing together the terminal portions 11, 12 of the group of at least two grouped conductive elements A, mutually locking them together.

Such element 7 can also profitably determine a partial locking together of the terminal portions 11, 12, for example by limiting only one degree of freedom. According to the specific application of the invention, the most suitable element 7 configured for the locking together of the terminal portions can be selected: in an extremely simplified embodiment, such element 7 could also be constituted by the method of coupling (by welding, clamping, crimping and the like) of the terminal portions 11, 12.

By way of non-limiting example, it should be noted that the device 1 according to the invention could comprise an element 7 configured for grouping (and also for at least partial locking together) terminal portions 11, 12 of groups of at least two conductive elements A of the type described in the EP2684283 in the name of this same Applicant, which is adapted to also perform operations of alignment of the terminal portions 11, 12 of the conductive elements A in predefined directions. However, the possibility is not ruled out of adopting grouping elements of different types, which are adapted to bring together groups (for example pairs) of terminal portions 11, 12 of conductive elements A with or without aligning them.

The device 1 according to the invention comprises a pusher 3 associated with movement means 4.

According to a possible embodiment, such movement means could be operative along a direction parallel to the slots D of the ferromagnetic core C: with particular reference to the accompanying figures (which are provided by way of non-limiting example of the present invention) the pusher 3 can be moved by the movement means 4 along a vertical path of approach/distancing to/from the ferromagnetic core C. Embodiments are not ruled out in which the core C can be oriented differently and in which therefore the stroke of the pusher 3 takes a different direction (therefore not parallel to the direction of the slots D).

The movement of the pusher 3 occurs along a programmable and predefined stroke: in practice, the entire law of motion can be programmed for the purpose of defining with precision the extent of the stroke, the speed of movement and, optionally, maintaining the pusher 3 at preset positions for specific time intervals.

In particular, the pusher 3 can advantageously move along a translation direction that is substantially parallel to the central axis of symmetry Y of the ferromagnetic core C, between a first operating configuration of maximum distance from the ferromagnetic core C, in which a flat abutment surface 5 thereof will conveniently be facing and proximate to the fronts E of the terminal portions 11, 12 of the conductive elements A (the configuration shown for the purposes of non-limiting example in the accompanying FIGS. 1 and 2), and a second operating configuration of minimum distance from the ferromagnetic core C, in which the flat abutment surface 5 will abut against the fronts E of the terminal portions 11, 12 of the conductive elements A, thus producing the alignment thereof on a common plane as a consequence of a deformation of the conductive elements A (as shown for the purposes of non-limiting example in the accompanying FIG. 3).

It should be noted that the deformation of the conductive elements A (in particular of their terminal portions 11, 12 protruding from the ferromagnetic core C) induced by the pusher 3 can occur both elastically and non-elastically: such deformations can therefore also be permanent.

It is important to note that the element 7 configured for grouping terminal portions 11, 12 of groups of at least two conductive elements A, after the alignment of the corresponding terminal fronts E performed by the pusher 3 in the cited second operating configuration thereof and before the pusher 3 leaves such second operating configuration, will bring together groups of terminal portions 11, 12 (for example pairs), thus ensuring the maintenance of the alignment generated by the pusher 3 even after the latter has been moved away (as shown by way of non-limiting example in the accompanying FIG. 4).

The at least one element 7 configured for grouping terminal portions 11, 12 of groups of at least two conductive elements A can conveniently be arranged downstream of the pusher 3: in this manner it will ensure grouping (and, in specific implementation architectures, also their mutual locking together) such groups of terminal portions 11, 12 when the pusher 3 has been moved closer to the ferromagnetic core C, bringing it to the second operating configuration. In such second operating configuration, the pusher 3 imposes the alignment of the fronts E of the terminal portions 11, 12 of the elements A via the abutment of the flat abutment surface 5 against them, and their possible and optional locking together, in groups (for example in pairs) in such configuration ensures that then they can be more easily coupled to each other (via various techniques, among which, for example, welding constitutes a preferred option).

In order to illustrate in more detail a possible embodiment of certain applicative interest, it should be noted that the at least one element 7 configured for grouping terminal portions 11, 12 of groups of at least two conductive elements A can profitably comprise means for clamping 7a the terminal portions 11, 12 of the conductive elements A. Such means for clamping 7a will be adapted to the juxtaposition and alignment of the terminal portions 11, 12, according to at least one direction that is defined on a plane perpendicular to the translation direction of the pusher 3.

With particular reference to an alternative embodiment, the at least one element 7 configured for grouping terminal portions 11, 12 of groups of at least two conductive elements A can usefully comprise means for clamping 7a the terminal portions 11, 12 of groups 1 of conductive elements A which are adapted to the juxtaposition and alignment of the terminal portions 11, 12 according to two separate directions which are mutually perpendicular and are also perpendicular to the translation direction of the pusher 3.

With particular reference to such embodiment, it should be noted that a particularly efficient version thereof is described in the EP2684283 in the name of this same Applicant, wherein the element 7a configured for grouping terminal portions 11, 12 of groups of at least two conductive elements A can comprise crimping means designed to compact and align the terminal portions 11, 12 of groups of conductive elements A according to two separate directions that are perpendicular to the longitudinal axis of the terminal portions.

In particular, since in EP2684283 reference is made, for the purposes of example, to manufacturing an inductive winding of a stator S of an electric motor, the element 7 configured for grouping terminal portions 11, 12 of groups of at least two conductive elements A will be provided with a first crimping means which performs a tangential compacting (the crimping of which occurs via an angular counter-rotation of respective jaws which, by coming together, lock the terminal portions of each individual group of conductive elements A together, thus producing the alignment thereof along a radial direction) and with a second crimping means which performs a radial compaction (the crimping of which occurs via bringing together mutually opposite clamp jaws along a radial direction, with consequent compaction of the terminal portions of each individual group of conductive elements A up until the complete juxtaposition of their facing surfaces).

This embodiment makes it possible to combine the technical advantages of the present invention, by virtue of which it is possible to arrange all the fronts E of the terminal portions 11, 12 of the groups of conductive elements A at the same distance from the ferromagnetic core C, thus ensuring that all the terminal portions of the conductive elements A protrude from the ferromagnetic core C in the same way, with the technical advantages described in EP2684283, by virtue of the fact that it is possible to achieve a radial and tangential alignment of the terminal portions of the conductive elements A.

It should be noted that the coupling of the terminal portions of the conductive elements A, which is necessary in order to close the circuits that constitute the inductive windings B, is generally achieved by welding: the correct mutual alignment (along all the directions) of the terminal portions 11, 12 of the conductive elements A determines the best mutual arrangement of such portions 11, 12 with consequent increase of the quality and of the stability/mechanical strength (for example resistance to tearing) of the weld that can be executed between such parts.

It should be noted that in a particularly useful and efficient embodiment of the present invention, the device 1 is designed to operate on a ferromagnetic core C constituted by the stator S of a rotating electric machine, of the type chosen from an electric motor, an alternator, a dynamo and the like (in compliance with what is shown by way of non-limiting example in the accompanying figures).

In such case, the flat abutment surface 5 of the pusher 3 will comprise an abutment pad 6 which is shaped like an annulus and dimensioned to abut against the fronts E of the terminal portions 11, 12 of the conductive elements A which are inserted into the slots D of the ferromagnetic core C.

By analyzing an embodiment like the one illustrated by way of non-limiting example in the accompanying figures, the abutment pad 6 could have an external outline having shape and dimensions complementary to those of the corresponding ferromagnetic core C from which the terminal portions 11, 12 of the conductive elements A protrude, which are provided with the fronts E against which it will abut with its respective flat abutment surface 5.

In the specific case corresponding to the application of the device 1 for the alignment of terminal portions 11, 12 of conductive elements A of a stator S of a rotating machine, the abutment pad 6 will be advantageously shaped like a disk provided with the flat abutment surface 5 on the face thereof that is directed, during operation, toward the ferromagnetic core C and, on the opposite face thereof, with means for coupling to at least one respective actuator (comprised in the movement means 4).

More precisely, and according to the embodiments illustrated in the accompanying figures by way of non-limiting example, the abutment pad 6 can profitably be shaped like an annulus (i.e. having an annular shape) provided with the flat surface 5 on the face thereof that is directed, during operation, toward the ferromagnetic core C and, on the opposite face thereof, with means for coupling to at least one respective actuator (comprised in the movement means 4).

The present invention also extends its protection to include a method for the alignment of conductive elements A, each one shaped like a fork comprising two shanks 8, 9 which are mutually connected by a bridge-shaped cross-piece 10.

It should be noted that in one of the possible application solutions of the method according to the invention, the conductive elements A could be part of inductive windings B. Such inductive windings B (in the embodiment given above) will be installed in a ferromagnetic core C which accommodates, in its respective slots D, a plurality of such conductive elements A which have terminal portions 11, 12 that at least partially protrude from a head H thereof.

The method according to the invention entails a first step of arranging a ferromagnetic core C which has a central axis of symmetry Y and a plurality of slots D which are arranged circumferentially (i.e. along the progression of the side surface of the core C) and parallel to the axis of symmetry Y thereof.

In a second step it will be necessary to insert the conductive elements A into the slots D so as to have the respective terminal ends 11, 12 of their shanks 8, 9 protrude from the ferromagnetic core C (in particular, protruding from the head H of the core C).

A third step will entail arranging a pusher 3 with a flat abutment surface 5 which is arranged facing the terminal ends 11, 12 of the shanks 8, 9 protruding from the ferromagnetic core C.

The method will then proceed to a fourth step of moving mutually closer, along a direction parallel to the axis of symmetry Y of the ferromagnetic core C, the pusher 3 and the head H of the ferromagnetic core C along a stroke Z of predefined extent, with the consequent abutment of the front E of the free ends of the terminal portions 11, 12 of the conductive elements A against the flat abutment surface 5. Such abutment will produce the deformation of the terminal portions 11, 12.

The pusher 3 and the head H can be moved closer together via a translation of the pusher 3 toward the head H, via a translation of the entire ferromagnetic core C toward the pusher 3, and/or via a movement of both components (toward each other).

As a function of the material with which the conductive elements A will be made and as a function of the extent of its deformation, the extent can be of the permanent type (in that the range of elastic deformation will be exceeded, resulting in plastic deformations) or non-permanent (if the deformations are solely elastic).

A fifth step of the method according to the invention consists in grouping the terminal portions 11, 12 of the conductive elements A (which will be arranged mutually close in preset arrangements), forming groups constituted by at least two terminal portions 11, 12 of respective conductive elements A. In this manner the mutually-coupled terminal portions 11, 12 (which thus form a group thereof) will have the respective fronts E perfectly axially aligned (i.e. they will all be arranged at the same distance from the ferromagnetic core C and therefore lying on a same plane), by virtue of the presence of the pusher 3 which imposes such condition of alignment.

In a subsequent sixth step, the pusher 3 and the head H of the core C are mutually spaced apart (via the same movement criteria described above: translation of the pusher 3 only, translation of the ferromagnetic core C only, and/or translation of both components), releasing the front E of the terminal portions 11, 12 of the groups of conductive elements A.

In this manner the correct alignment of the fronts E of the terminal portions 11, 12 of the groups of conductive elements A will be reached, thus achieving the set objective.

The fifth step of mutually grouping can conveniently consist in the juxtaposition and alignment of the terminal portions 11, 12, according to at least one direction lying on a plane perpendicular to the translation direction of the pusher 3.

The sixth step of mutually spacing apart the pusher 3 and the ferromagnetic core C, for the release of the front E of the terminal portions 11, 12 of the groups of conductive elements A, entails a movement of the pusher 3 to a distance from the ferromagnetic core C that is greater than the operating space occupation of the apparatuses used during the step of coupling the terminal portions 11, 12, for the purpose of having all the space necessary to execute a step of mutual coupling, if required.

It should be noted that, with specific reference to a particularly efficient embodiment, the steps of moving the pusher 3 and the ferromagnetic core C mutually closer together and further apart can occur preferably via the translation of the pusher 3, keeping the ferromagnetic core C stationary.

It should furthermore be noted that, at the end of a method for the mutual alignment of the portions 11, 12 of conductive elements A of the type described above, there can advantageously be an additional step of mutual coupling of the terminal portions 11, 12 of the groups of conductive elements A.

Therefore an additional operating step, in which the terminal portions 11, 12 of the groups of conductive elements A can be mutually coupled, in so doing completing the circuits that constitute the inductive windings B, can be optionally adopted at the end of the method described previously.

It should be noted that such additional and optional step of mutual coupling of the terminal portions 11, 12 of groups of conductive elements A can advantageously entail the adoption of a technique chosen from welding (the preferred solution), clamping with a vise, clamping with a rivet, clamping with threaded means, clamping with a perimetric ring.

Among the possible welding techniques it should be noted that laser welding, in particular using a fiber laser, is particularly indicated for the present application. However, the possibility is not ruled out of using different welding techniques or different methods of mutual coupling of the terminal portions of groups of conductive elements A.

Advantageously the present invention solves the above mentioned problems, by providing a device 1 for the alignment of conductive elements A that is particularly precise: the device 1 ensures in fact that the front E of all the terminal portions 11, 12 of the conductive elements A is located at the same distance from the face of the ferromagnetic core C from which they protrude (thus ensuring that all the terminal portions 11, 12 protrude to the same extent from such face, the head H, of the ferromagnetic core C).

Conveniently the device 1 according to the invention is adapted to arrange the front E of the terminal portions of pairs (or groups) of conductive elements A at a same height/distance from the ferromagnetic core C.

Usefully the device 1 according to the invention is of the completely automated type.

Profitably the device 1 according to the invention rapidly determines the condition of ideal alignment of the heads (the fronts E) of the terminal portions 11, 12 of the conductive elements A (by making use of a simple operation).

Positively the device 1 according to the invention can be associated with other, conventional devices for alignment (by way of non-limiting example the element configured for the locking together and alignment of the terminal portions of conductive elements described in the Patent EP2684283 in the name of the same applicant).

Positively the device 1 according to the invention is easily and practically implemented and is of low cost: such characteristics make the device 1 according to the invention an innovation that is safe in use.

The invention, thus conceived, is susceptible of numerous modifications and variations, all of which are within the scope of the appended claims. Moreover, all the details may be substituted by other, technically equivalent elements.

In the embodiments illustrated, individual characteristics shown in relation to specific examples may in reality be interchanged with other, different characteristics, existing in other embodiments.

In practice, the materials employed, as well as the dimensions, may be any according to requirements and to the state of the art.

The disclosures in Italian Patent Application No. 102021000028556 from which this application claims priority are incorporated herein by reference.

Where technical features mentioned in any claim are followed by reference signs, those reference signs have been included for the sole purpose of increasing the intelligibility of the claims and accordingly, such reference signs do not have any limiting effect on the interpretation of each element identified by way of example by such reference signs.

1-11. (canceled)

12. A device for an alignment of conductive elements, each conductive element being shaped like a fork comprising two shanks which are mutually connected by a bridge-shaped cross-piece, said shanks being provided with terminal portions which have a respective front which is flat at the free end, said device comprising a frame for a temporary support of a ferromagnetic core which has a central axis of symmetry and has slots configured to accommodate a plurality of said shanks of said conductive elements, and at least one grouping element configured for the optionally partial grouping of said terminal portions of groups of at least two conductive elements, further comprising a pusher associated with movement means which operate along a programmable and predefined stroke, said pusher being movable along a translation direction that is substantially parallel to the central axis of symmetry of the ferromagnetic core between a first operating configuration of maximum distance from said ferromagnetic core, in which a flat abutment surface of the pusher is facing at a distance the respective fronts of the terminal portions of said conductive elements, and a second operating configuration of minimum distance from said ferromagnetic core, in which said flat abutment surface abuts against the respective fronts of the terminal portions of said conductive elements, thus producing an alignment thereof as a consequence of a deformation of said conductive elements.

13. The device according to claim 12, wherein said at least one grouping element is configured for grouping terminal portions of groups of at least two conductive elements in said second operating configuration, said grouping element being interposed between said pusher and the ferromagnetic core.

14. The device according to claim 13, wherein said at least one grouping element comprises means for clamping said terminal portions of said conductive elements, which are adapted to the juxtaposition and alignment of said terminal portions, according to at least one direction on a plane that is perpendicular to the translation direction of said pusher.

15. The device according to claim 13, wherein said flat abutment surface of the pusher is provided on an abutment pad which is shaped like an annulus and dimensioned to abut against the respective fronts of the terminal portions of said conductive elements which are inserted into the slots of the ferromagnetic core.

16. The device according to claim 12, wherein said ferromagnetic core belongs to a stator of an electric machine.

17. A method for an alignment of conductive elements, each one shaped like a fork comprising two shanks which are mutually connected by a bridge-shaped cross-piece, comprising the following steps:
arranging a ferromagnetic core which has a central axis of symmetry and a plurality of slots which are arranged circumferentially and parallel to the axis of symmetry;
inserting conductive elements into said slots so as to have terminal ends of said shanks protruding from the ferromagnetic core;
arranging a pusher with a flat abutment surface which is arranged facing terminal portions of said shanks protruding from the ferromagnetic core;
moving mutually closer, along a direction parallel to the axis of symmetry of the ferromagnetic core, said pusher and a head (H) of said ferromagnetic core along a stroke (Z) of predefined extent, with a consequent abutment of a front of free ends of said terminal portions against said flat abutment surface, with consequent deformation of said terminal portions;
mutually grouping said terminal portions of said conductive elements, forming groups constituted by at least two terminal portions of respective conductive elements;
mutually moving apart said pusher and said ferromagnetic core, releasing said terminal portions of said groups of conductive elements.

18. The method according to claim 17, wherein said step of mutually grouping consists in a juxtaposition and alignment of said terminal portions, according to at least one direction lying on a plane that is perpendicular to a translation direction of said pusher.

19. The method according to claim 18, wherein said step of mutual spacing apart of said pusher and said ferromagnetic core, for the release of the front of said terminal portions of said groups of conductive elements, entails a movement of the pusher to a distance from the ferromagnetic core that is greater than an operating space occupation of apparatuses for coupling said terminal portions.

20. The method according to claim 17, wherein said steps of moving mutually closer and mutually apart of said pusher and said ferromagnetic core occur via the translation of said pusher, while keeping said ferromagnetic core stationary.

21. A method for coupling conductive elements of inductive windings of a ferromagnetic core, wherein, at an end of a method for alignment according to claim 17, comprises a step of:
mutually coupling said terminal portions of said groups of conductive elements.

22. The method according to claim 21, wherein said step of mutual coupling of said terminal portions of said groups of conductive elements comprises a technique chosen from welding, clamping with a vise, clamping with a rivet, clamping with threaded means, clamping with a perimetric ring.
